(19) United States
(12) Patent Application Publication
(10) Pub. No.: US 2007/0182105 A1
(43) Pub. Date: Aug. 9, 2007

(54) Seal configuration

(75) Inventors: Elizabeth Chitren, Fairport, NY (US); John Minier, Webster, NY (US)

Correspondence Address: KILPATRICK STOCKTON LLP, 607 14TH STREET, N.W., WASHINGTON, DC, 20005, US

(73) Assignee: Garlock Sealing Technologies, LLC. a Delaware Corporation

(21) Appl. No.: 11/656,429

(22) Filed: Jan. 23, 2007

Related U.S. Application Data
(60) Provisional application No. 60/762,140, filed on Jan. 26, 2006.

(51) Int. Cl. F16J 15/32

(52) U.S. Cl. 277/562

(57) ABSTRACT

A seal configuration described herein is a seal that less likely to clog, requires low maintenance, and more cost effective than conventional designs. For example, a seal configuration for a shaft sleeve has a unitary piece having at least two curved lip elements extending radially inwardly from the unitary piece to the shaft sleeve and at least two spacers extending radially inwardly from the unitary piece to substantially near the shaft sleeve. The unitary piece has an alternating arrangement of lip elements and spacers. The shaft sleeve can be made of silicon carbide.

### CROSS-REFERENCE TO RELATED APPLICATIONS

This application claims priority to U.S. Provisional Patent Application Ser. No. 60/762,140, filed Jan. 26, 2006, which is hereby incorporated by reference in its entirety.

### BACKGROUND OF THE INVENTION

1. Field of the Invention

This invention relates to a seal configuration that incorporates both lip elements and spacers.

2. Description of the Related Art

Seals are designed to prevent leakage between a rotating shaft and its housing under conditions of extreme pressure, shaft speed, and temperature. A lip seal is an elastomeric seal that prevents leakage in dynamic and static applications by reason of controlled interference between the seal lip and the mating surface.

A conventional lip seal has a cylindrical case and whose inner circumferential portions are curved toward a sealed fluid and put in sliding contact with the outside circumferential surface of a shaft extending through the cylindrical case. The conventional seal may have one or more lip elements in sliding contact with the shaft. Spacers are often added to a lip seal in order to ensure proper positioning and maintain alignment. In a conventional lip seal, the at least one spacer is separate from the lip seal in order to facilitate installation. Additionally, the spacer is often constructed from metal, which can cost more to machine.

The conventional configurations require separate components to form the seal, which can increase production costs and require additional maintenance for each component. Further, multiple components may cause additional clogging. Moreover, installation in the field or plant is more difficult and costly. Additionally, lip seals typically have a high cost of coating a sleeve.

### SUMMARY OF THE INVENTION

What is desired is a seal that less likely to clog, requires low maintenance, and more cost effective than conventional designs. The seal configuration of the present invention attempts to resolve these issues.

In one embodiment, a seal configuration for a shaft sleeve comprises a unitary piece comprising at least two curved lip elements extending radially inwardly from the unitary piece to the shaft sleeve; and at least two spacers extending radially inwardly from the unitary piece to substantially near the shaft sleeve; wherein the unitary piece comprises an alternating arrangement of lip elements and spacers.

In another embodiment, a seal configuration comprises a shaft sleeve comprising silicon carbide and a sealing component comprising at least two lip elements curving from the unitary piece to the shaft sleeve and at least one spacer between each lip element and extending radially inwardly from the sealing component to substantially near the shaft sleeve.

In yet another embodiment, a seal comprises a first, second, and third lip element extending from a block component to a shaft sleeve; and a first and second spacer extending from the block component in a direction towards to the shaft sleeve; wherein the first spacer is disposed between the first and second lip elements and wherein the second spacer is disposed between the second and third lip elements.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The present invention will be more clearly understood from a reading of the following description in conjunction with the accompanying exemplary figures wherein:

FIG. 1 shows a perspective view of a seal according to an embodiment of the present invention;

FIG. 2a shows a frontal view of the seal; and

FIG. 2b shows the cross section of the seal through the line A-A.

### DETAILED DESCRIPTION

Reference will now be made in detail to the preferred embodiments of the present invention, examples of which are illustrated in the accompanying drawings.

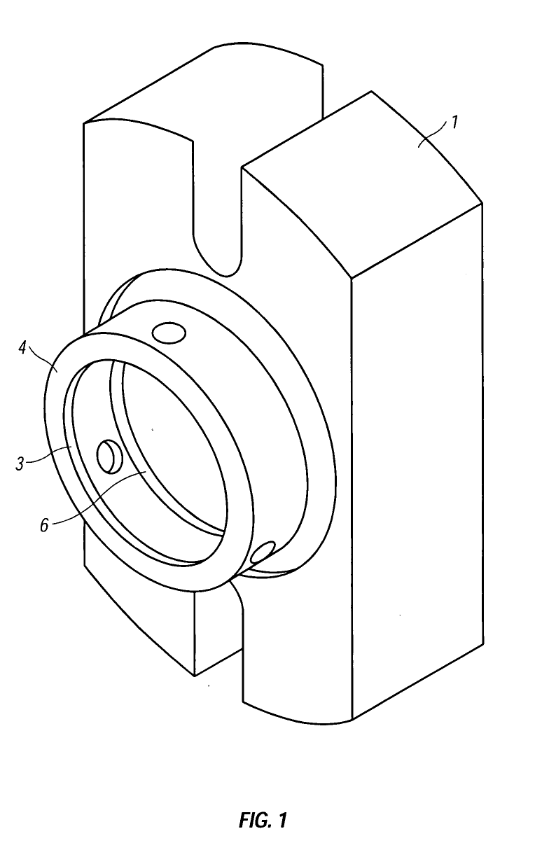

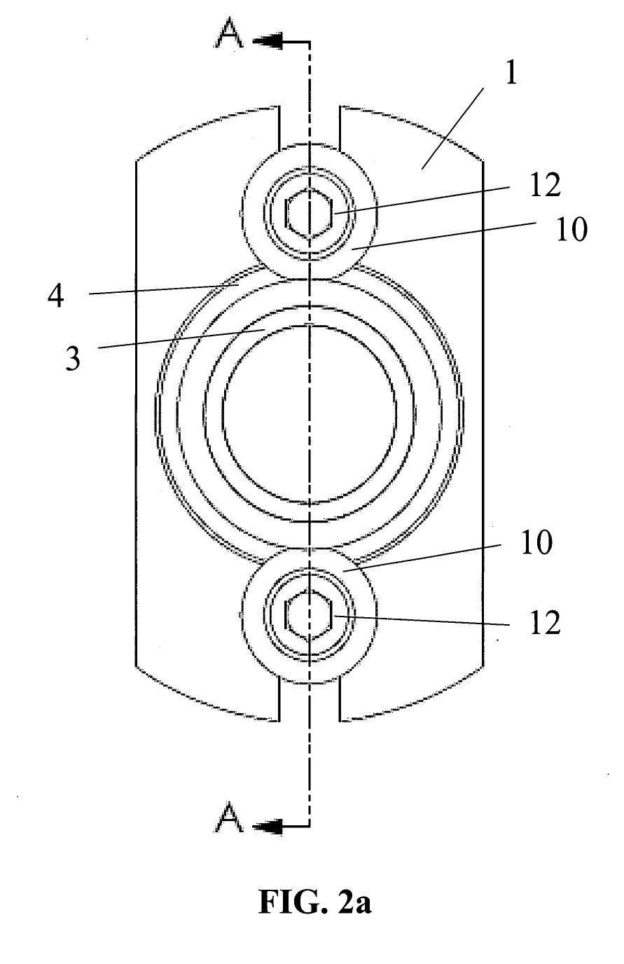

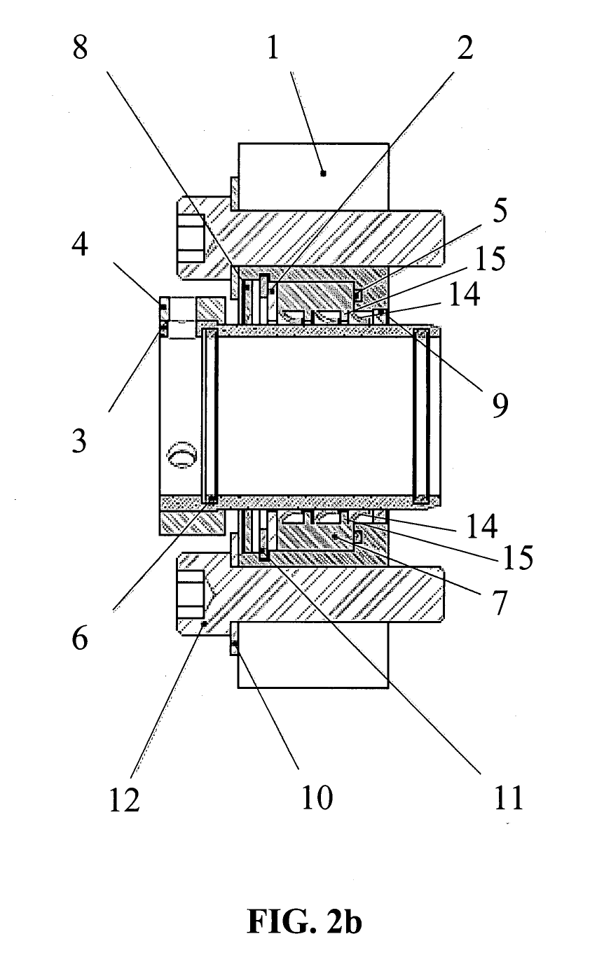

FIGS. 1 and 2a depict a gland 1 having lip seal configuration according to an exemplary embodiment of the present invention. This configuration can allow extreme design versatility and facilitate quick and simple in-plant repair. Referring to FIG. 2b, the gland 1 comprises a block piece 7, that incorporates both lip elements 14 and spacers 15 in a single body, as compared to conventional configurations that utilize separate lip elements and spacers. The curvature of lip elements 14 can be dependent upon the direction of the pressure. Alternatively, the lip elements 14 can be curved in a reverse direction in order to seal out high air pressure.

In this exemplary embodiment, the block piece 7 has three lip elements 14, although the number of lip elements 14 can vary as long as at least one lip element is used. A lesser amount of lip elements 14 can be preferable when there are constraints on available space. A desirable number of lip elements 14 can also depend on the fluid to be sealed. Accordingly, the number of spacers 15 can also vary, based on the fluid and the number of lip elements 14.

As a result of the unitary design of the block piece 7, the lip elements 14 are supported by spacers 15 of the block piece 7 within the gland 1. The spacers 15 can function as a check valve in the case that the lip element 14 fails. The dimensions of the spacers 15 can vary. In an exemplary embodiment, however, there is a space between the spacers 15 and a shaft sleeve 3. In some instances, it can be preferable to have a space between the spacers 15 and the shaft sleeve 3 be as small as possible. In an alternative embodiment, centering ring 9 can be integrated into the block piece 7 to act as a spacer 15. A spacer 2, which can be made from metal, can assist in preventing deformation of the block piece 7.

In a preferred embodiment, the block piece 7 is made of polytetrafluoroethylene (“PTFE”). However, block piece 7 can be constructed of any other plastic material known to one of ordinary skill in the art.

A shaft sleeve is the inner barrel of a balanced rotating seal. Block piece 7 is positioned against the shaft sleeve 3 to seal out a process fluid. A sleeve collar 4 attaches to the rotating shaft. In an alternative embodiment, the gland 1 can be configured without a shaft sleeve 3. Additionally, the gland 1 can also be configured to include a vacuum or staged taps (not shown). The gland 1 also houses the components and bolts to a pump housing. Washers 10, snap rings 11, and centering rings 8 and 9 set axial movement, hold the seal together, and center the lip elements 14 on a rotating shaft. A plurality of o-rings 5, 6 may also be used in this configuration.

Furthermore, to reduce the cost of hard-coating and grinding the normal running surface of the shaft sleeve 3, the shaft sleeve 3 is produced from a lubricious, yet very hard surface, such as silicon carbide. In an alternative embodiment, the shaft sleeve can be formed from a different material, such as chrome oxide stainless steel. Silicon carbide offers a wide range of chemical resistance. Silicon carbide is very hard, giving it excellent abrasion resistance. Additionally, silicon carbide offers the highest heat transfer characteristics essential for effective sealing of high temperature liquids. Silicon carbide is available in a variety of grades.

The gland 1 is machined to fit a wide variety of equipment and applications. When using the shaft sleeve 3, the lip elements 14 will not damage equipment. Also, the lip elements 14 are not housed in a metal shell, such as in conventional configurations. Thus, the use of the block piece 7 having the lip elements 14 and spacers 15 as well as the silicon carbide shaft sleeve 3 can be easier to manufacture and assemble, which also reduces costs. As a result, the configuration as shown in the exemplary embodiments of FIGS. 1, 2a, and 2, is advantageous over conventional configurations.

Among the many uses, the seal may be used in positive displacement pumps moving viscous materials, often without environmental controls. Because the seal has simply configured elements, easy and economical in-field repair is possible. Further, the seal is less likely to clog in viscous materials.

Materials used in this configuration can be varied depending upon the application, as known to one of ordinary skill in the art. However, it is desirable that the changes in materials do not affect the primary advantages of a unitary body having both the lip elements and spacers as well as a lubricious shaft sleeve.

The embodiments described above are intended to be exemplary. One skilled in the art recognizes that numerous alternative components and embodiments that may be substituted for the particular examples described herein and still fall within the scope of the invention.

What is claimed is:

1. A seal configuration for a shaft sleeve, the seal configuration comprising:
a unitary piece comprising:
at least two curved lip elements extending radially inwardly from the unitary piece to the shaft sleeve; and
at least two spacers extending radially inwardly from the unitary piece to substantially near the shaft sleeve;
wherein the unitary piece comprises an alternating arrangement of lip elements and spacers.

2. The seal configuration according to claim 1, wherein the unitary piece comprises polytetrafluoroethylene.

3. The seal configuration according to claim 1, wherein the shaft sleeve comprises silicon carbide.

4. The seal configuration according to claim 1, wherein the unitary piece comprises two lip elements.

5. The seal configuration according to claim 1, wherein the unitary piece comprises three lip elements.

6. The seal configuration according to claim 1, wherein the unitary piece comprises four lip elements.

7. The seal configuration according to claim 1, wherein the unitary piece comprises two spacers.

8. The seal configuration according to claim 1, wherein the unitary piece comprises three spacers.

9. The seal configuration according to claim 1, wherein the shaft sleeve comprises chrome oxide stainless steel.

10. The seal configuration according to claim 1, wherein the unitary piece is disposed between a first and second centering ring.

11. A seal configuration comprising:
a shaft sleeve comprising silicon carbide; and
a sealing component comprising:
at least two lip elements curving from the unitary piece to the shaft sleeve; and
at least one spacer between each lip element and extending radially inwardly from the sealing component to substantially near the shaft sleeve.

12. The seal configuration according to claim 11, wherein the sealing component comprises polytetrafluoroethylene.

13. The seal configuration according to claim 11, wherein the sealing component comprises two lip elements and one spacer.

14. The seal configuration according to claim 11, wherein the sealing component comprises three lip elements and two spacers.

15. The seal configuration according to claim 11, wherein the sealing component comprises four lip elements and three spacers.

16. The seal configuration according to claim 11, wherein the sealing component is disposed between a first and second centering ring.

17. A seal comprising:
a first, second, and third lip element extending from a block component to a shaft sleeve; and
a first and second spacer extending from the block component in a direction towards to the shaft sleeve;
wherein the first spacer is disposed between the first and second lip elements and wherein the second spacer is disposed between the second and third lip elements.

18. The seal according to claim 17, wherein the block component comprises polytetrafluoroethylene.

19. The seal according to claim 17, wherein the shaft sleeve comprises silicon carbide.

20. The seal according to claim 17, wherein the shaft sleeve comprises chrome oxide stainless steel.

21. The seal according to claim 17, wherein the block component is disposed between a first and second centering ring.
